(19) United States
(12) Patent Application Publication
(10) Pub. No.: US 2010/0180287 A1
(43) Pub. Date: Jul. 15, 2010

(54) AUTOMATED OPTICAL DISK LOADING RACK

(76) Inventor: Tejesh C. Makanawala, Mountain View, CA (US)

Correspondence Address: Tejesh Makanawala, 1951 Plymouth Street, Mountain View, CA, 94043, US

(21) Appl. No.: 12/676,911

(22) PCT Filed: Oct. 19, 2007
(86) PCT No.: PCT/US2007/081872

§ 371 Date: Mar. 8, 2010

(51) Int. Cl. G11B 17/04

(52) U.S. Cl. 720/617; G9B/17.013

(57) ABSTRACT

A disc holder (16) rack and 2 moving disk drives (14). The disk holder (16) holds disks (18) from top via vacuum. The discs (18) get released by air entering the vacuum area, thus pushing the disc (18) down. The other part of the invention is the disc drive (14) that is mounted on a vertical drive mechanism (10, 46). By mounting the disc drive (14) directly on the vertical drive mechanism (10, 46), the intermediate transfer robot is eliminated. The drive mount(46) complies with the standard one in the computer industry, thus upgrading disc drives (14) is simplified.

### FIELD OF THE INVENTION

The present invention relates to the design of an automated optical disc loading rack system and, more particularly, to how the design simplifies the loading and unloading of optical discs into an optical drive process, while allowing upgradability of drive as advances in drive technology continue.

### BACKGROUND OF THE INVENTION

Ever since discs have been used for data, audio and video storage, managing discs has not been very efficient. This is an issue for both consumers and businesses. The discs are stored in cupboards and requires significant manual organizing.

Most common solution for audio discs in the consumer market is the 6 disc CD changer, and more recently the conversion of CD data into MPEG files for storage in IPOD style MP3 players.

The solutions in existence may be adequate for audio storage, but data storage for business and video storage for consumers require greater storage capacity.

It is therefore an object of the invention to provide a mechanism to store the wafer from the top with vacuum.

It is another object of the invention to directly load disc from rack to disc drive without an intermediate transfer mechanism.

It is another object of the invention to use a disc drive mounting scheme that allows installation of an off the shelf disc drive, thus upgrading to newer versions of disc drives becomes simple and cost effective.

### SUMMARY OF THE INVENTION

In accordance with the present invention, there is provided a disc media holder rack and 2 moving disc drives. The disc drives are moved to where the disc media are located, and are directly placed into the disc drive. By loading directly, the need for an intermediary transfer robotic mechanism is eliminated. This disc media are held from the top via vacuum, and are released by gravity after a vacuum leak situation is created. Holding the wafers from the top via vacuum eliminates the potential for possible scratches and the need for additional disc media protection covers. The disc drives used are standard ones used in the computer industry, and the drive mount complies with the standard one in the computer industry. This allows easy upgrade of the equipment from from DVD drives to Blue-ray or HD-dvd disc drive for example.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front partial view of a disc holding rack and moving disc loader. the left most vertical bar shown in the main vacuum rod. the left section shows the main vacuum rod attached with one individual vacuum rod. both the main vacuum rod and the individual vacuum rod are hollow, and are generally in vacuum. the individual vacuum rod has three potential sources of air inlet, though the one connected to the main vacuum rod is blocked via a check valve. the remaining two inlets are temporarily blocked via the spring loaded leak vacuum pin and the disc media holding suction cup. the right most vertical bar shown is the vertical lead screw. the right section shows the disc drive mechanically connected to vertical lead screw with a drive mount. the disc drive is shown in a loading position, where the suction cup was just attached to the disc media that resides in the disc holder. above the disc is the leak magnet solenoid, that is used to release the disc media from the suction cup;

FIG. 2 is a front view of a disc holding rack and moving disc loader. the left most vertical bar shown in the main vacuum rod attached to a vacuum pump shown at the bottom of the figure. the left section shows the main vacuum rod attached with seven individual vacuum rod. each individual vacuum rod is holding a disc media. the top most individual vacuum rod has disc media that was just loaded. the right most vertical bar shown is the vertical lead screw with a positioning motor attachment shown at the bottom. the vertical lead screw is attached to two disc drive via standard drive mount. in addition one leak magnetic solenoid is shown on each disc drive;

FIG. 3 is a detail view of an air flow for the vacuum system that holds and releases the disc media. there are 2 individual vacuum rod systems shown. the top one is releasing a disc media, whereas the bottom one is holding the disc media. the spring loaded leak vacuum pin allow air into the individual vacuum rod when it is pulled by the leak magnet solenoid. when air enters the individual vacuum bar, air also enters the suction cup, and the disc media is released. when disc media is loaded onto the suction cup, the air entering from the bottom of the suction cup is blocked, thus creating a vacuum. the vacuum is created because of the nature of loading the disc media onto the suction cup and the presence of a vacuum pump continuously drawing air from the enclosed individual vacuum rod;

FIG. 4 is a bottom view of a distribution for power to the various subsystems. the ac plug is shown on the left, the dc power supply is shown in the middle, and the four loads on the dc power supply are shown on the right. the four loads include the motion controller, the vacuum pump, the disc drive and the usb hub; and

FIG. 5 is a bottom view of a communication interface to the various subsystems. on the left are the devices that need to be controlled. they include the positioning motor, the two magnetic leak solenoids and the disc drive. the positioning motor and two magnetic leak solenoids are controlled via the motion controller, where as the disc drive is controlled directly. all control occurs from the external pc, which is shown on the right.

For purposes of clarity and brevity, like elements and components will bear the same designations and numbering throughout the Figures.

### DESCRIPTION OF THE PREFERRED EMBODIMENT

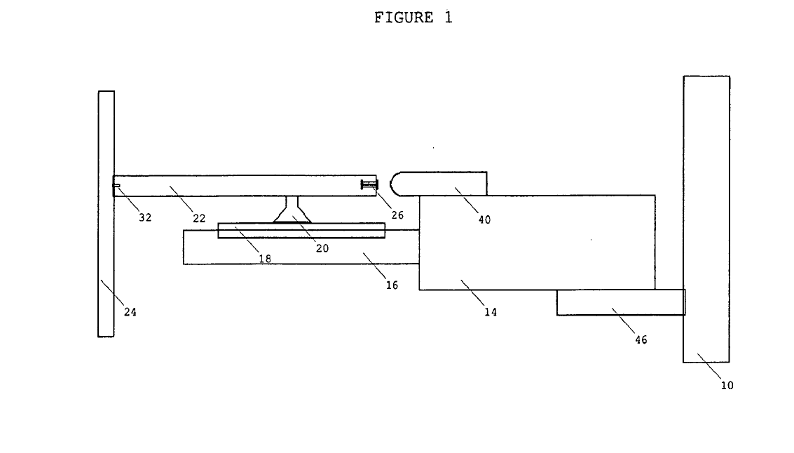

FIG. 1 is a front partial view of a disc holding rack and moving disc loader. the left most vertical bar shown in the main vacuum rod 24. the left section shows the main vacuum rod 24 attached with one individual vacuum rod 22. both the main vacuum rod 24 and the individual vacuum rod 22 are hollow, and are generally in vacuum. the individual vacuum rod 22 has three potential sources of air inlet, though the one connected to the main vacuum rod 24 is blocked via a check valve 32. the remaining two inlets are temporarily blocked via the spring loaded leak vacuum pin 26 and the disc media 18 holding suction cup 20. the right most vertical bar shown is the vertical lead screw 10. the right section shows the disc drive 14 mechanically connected to vertical lead screw 10 with a drive mount 46. the disc drive 14 is shown in a loading position, where the suction cup 20 was just attached to the disc media 18 that resides in the disc holder 16. above the disc is the leak magnet solenoid 40, that is used to release the disc media 18 from the suction cup 20.

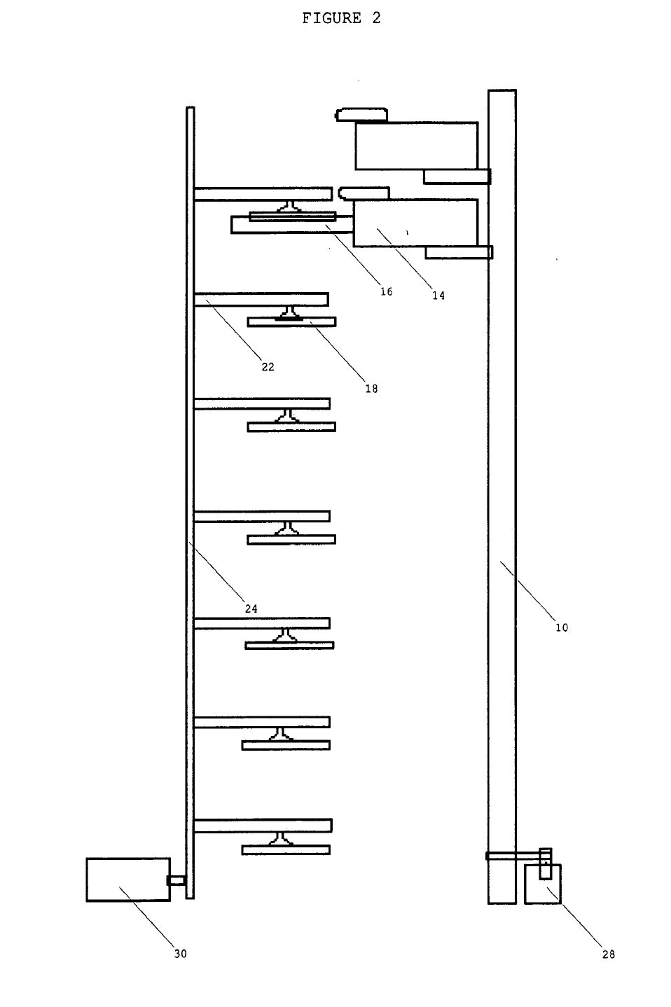

FIG. 2 is a front view of a disc holding rack and moving disc loader. the left most vertical bar shown in the main vacuum rod 24 attached to a vacuum pump 30 shown at the bottom of the figure. the left section shows the main vacuum rod 24 attached with seven individual vacuum rod 22. each individual vacuum rod 22 is holding a disc media 18. the top most individual vacuum rod 22 has disc media 18 that was just loaded. the right most vertical bar shown is the vertical lead screw 10 with a positioning motor 28 attachment shown at the bottom. the vertical lead screw 10 is attached to two disc drive 14 via standard drive mount 46. in addition one leak magnetic solenoid is shown on each disc drive 14.

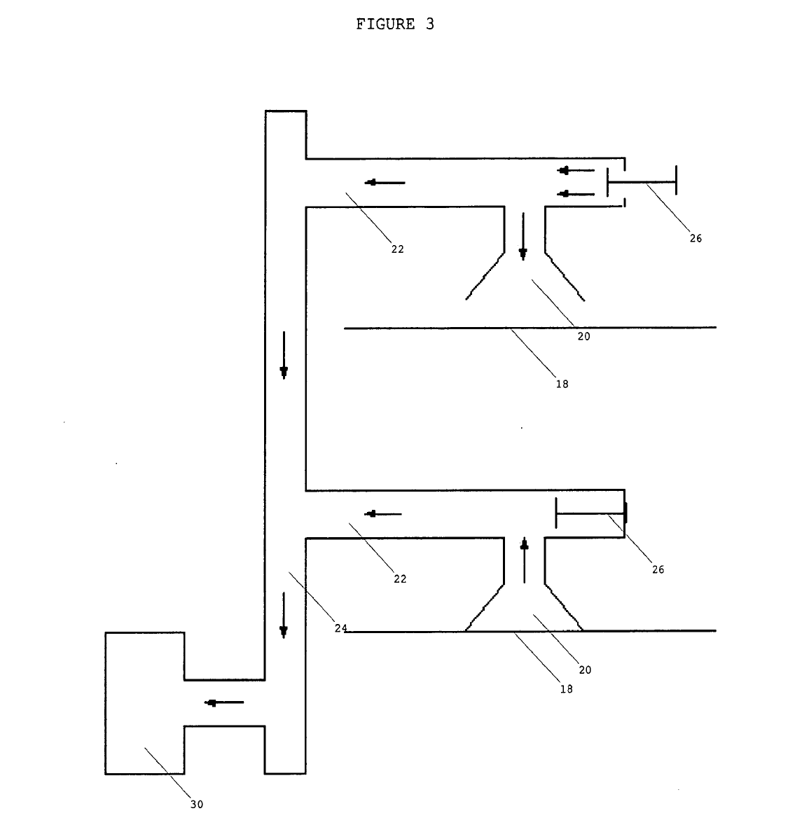

FIG. 3 is a detail view of an air flow for the vacuum system that holds and releases the disc media 18. there are 2 individual vacuum rod 22 systems shown. the top one is releasing a disc media 18, whereas the bottom one is holding the disc media 18. the spring loaded leak vacuum pin 26 allow air into the individual vacuum rod 22 when it is pulled by the leak magnet solenoid 40. when air enters the individual vacuum bar, air also enters the suction cup 20, and the disc media 18 is released. when disc media 18 is loaded onto the suction cup 20, the air entering from the bottom of the suction cup 20 is blocked, thus creating a vacuum. the vacuum is created because of the nature of loading the disc media 18 onto the suction cup 20 and the presence of a vacuum pump 30 continuously drawing air from the enclosed individual vacuum rod 22.

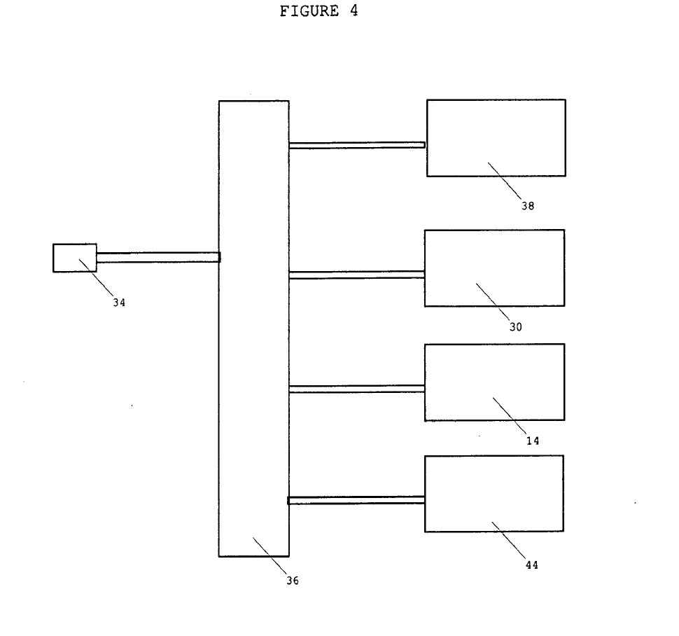

FIG. 4 is a bottom view of a distribution for power to the various subsystems. the ac plug 34 is shown on the left, the dc power supply 36 is shown in the middle, and the four loads on the dc power supply 36 are shown on the right. the four loads include the motion controller 38, the vacuum pump 30, the disc drive 14 and the usb hub 44.

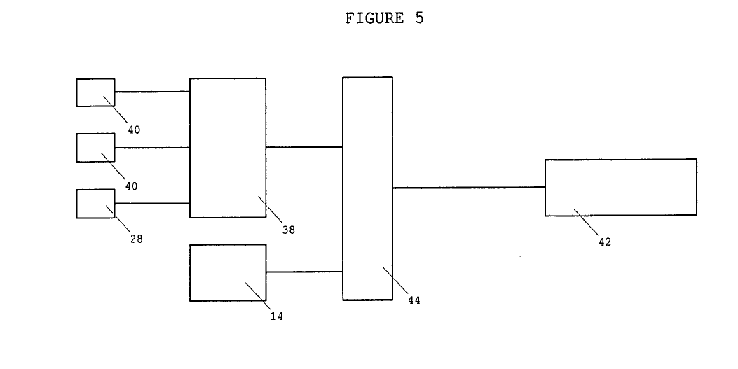

FIG. 5 is a bottom view of a communication interface to the various subsystems. on the left are the devices that need to be controlled. they include the positioning motor 28, the two magnetic leak solenoids and the disc drive 14. the positioning motor 28 and two magnetic leak solenoids are controlled via the motion controller 38, where as the disc drive 14 is controlled directly. all control occurs from the external pc 42, which is shown on the right.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An automated optical disk loading rack for directly loading an optical disc from any one of the many stored slots to an optical drive where data, audio or video can be read or written, comprising:
means for moving optical drive in vertical direction;
means for holding disk through suction; and
means for mount disc drive to vertical lead screw, rigidly connected to said means for moving optical drive in vertical direction.

2. The automated optical disk loading rack in accordance with claim 1, wherein said means for holding disk through suction comprises a suction cup.

3. The automated optical disk loading rack in accordance with claim 1, wherein said means for mount disc drive to vertical lead screw comprises a standard disc drive mounting scheme to allow easy disc drive upgrade drive mount.
